(19) United States
(12) Patent Application Publication
(10) Pub. No.: US 2026/0153412 A1
(43) Pub. Date: Jun. 4, 2026

(54) VIBRATING SPATULA

(71) Applicant: JAPAN ATOMIC ENERGY AGENCY, Naka-gun (JP)

(72) Inventors: Takahito OSAWA, Naka-gun (JP); Takuya NOZAWA, Naka-gun (JP); Yoko KOKUBU, Naka-gun (JP); Kazuhide ABE, Naka-gun (JP); Kimihiko IWATA, Anpachi-gun (JP)

(73) Assignee: JAPAN ATOMIC ENERGY AGENCY, Naka-gun (JP)

(21) Appl. No.: 19/389,969

(22) Filed: Nov. 14, 2025

(30) Foreign Application Priority Data
Nov. 29, 2024 (JP) 2024-208859

(51) Int. Cl. G01N 1/00

(52) U.S. Cl. CPC G01N 1/00; G01N 2001/002

(57) ABSTRACT

Provided is an electric vibrating spatula capable of vibrating a spatula portion of various shapes in an appropriate and intuitive manner, with excellent usability. The electric vibrating spatula includes: a hollow handle portion to be held by a user; a vibration mechanism housed inside of the handle portion and configured to vibrate with electric power; a spatula portion removably attached to a distal end of the handle portion and configured to vibrate in response to vibration of the vibration mechanism; and a switch portion provided on the handle portion and configured to be pressed by the user holding the handle portion. The switch portion changes a vibration state of the spatula portion in accordance with a magnitude of pressing force applied by the user.

### CROSS REFERENCE TO RELATED APPLICATIONS

This application claims the benefit of priority from Japanese patent application JP 2024-208859 filed on Nov. 29, 2024, the entire content of which is hereby incorporated by reference.

### BACKGROUND

### Technical Field

The present invention relates to an electric vibrating spatula.

### Background Art

Conventionally, radiocarbon dating is performed with an elemental analyzer and an automated graphitization device. While measurement itself in the elemental analyzer is automated, a sample analyzed in the elemental analyzer is often prepared manually. In the sample preparation process, a spatula (also referred to as a “dispensing spoon”) is used to load a sample into a container-shaped tinfoil having an opening at an upper end, and after the opening is closed, the tinfoil is squeezed from above to form a flat shape as an embedding operation. To make this embedding operation efficient, the sample needs to be efficiently loaded into the container-shaped tinfoil.

As a conventional technique for the spatula used for sample loading, JP S61-178431 U is known, for example. JP S61-178431 U discloses a powder dispensing spoon including a charge-storage capacitor, a resonant circuit made up of a series-connected circuit including the charge-storage capacitor or another capacitor and a coil, a switch to be inserted into the resonant circuit, an ultrasonic vibrator that vibrates by applying a voltage generated in the resonant circuit through operation of the switch, a vibrating spoon attached to the ultrasonic vibrator, and a case for housing the capacitor, the resonant circuit, and the ultrasonic vibrator, the case having the switch attached thereto.

### SUMMARY

In the powder dispensing spoon disclosed in JP S61-178431 U, replacing a spoon with another spoon having a different shape is not assumed, and only a constant vibration can essentially be applied. Thus, when the spoon having a different shape is used, the powder dispensing spoon disclosed in JP S61-178431 U may not be able to apply vibration enough to cause powder to drop satisfactorily. If a stronger vibration is initially set assuming such a possibility, the powder dispensing spoon disclosed in JP S61-178431 U may cause powder to spatter, wasting valuable powder.

The present invention has been made in view of the foregoing circumstances and provides an electric vibrating spatula capable of vibrating a spatula portion of various shapes in an appropriate and intuitive manner, with excellent usability.

To solve the above-described problems, the vibrating spatula of the present invention is a vibrating spatula of an electric type including: a handle portion to be held by a user, the handle portion being hollow; a vibration mechanism housed inside of the handle portion and configured to vibrate with electric power; a spatula portion removably attached to a distal end of the handle portion and configured to vibrate in response to vibration of the vibration mechanism; and a switch portion provided on the handle portion and configured to be pressed by the user holding the handle portion. The switch portion changes a vibration state of the spatula portion in accordance with a magnitude of pressing force applied by the user.

According to the present invention, it is possible to provide an electric vibrating spatula capable of vibrating a spatula portion of various shapes in an appropriate and intuitive manner, with excellent usability.

### BRIEF DESCRIPTION OF THE DRAWINGS

FIG. 1 is a side view of a vibrating spatula according to the present embodiment;

FIG. 2 is a view of the vibrating spatula taken along arrow II illustrated in FIG. 1;

FIG. 3 is a view of the vibrating spatula taken along arrow III illustrated in FIG. 1;

FIG. 4 is a cross-sectional view of a handle portion of the vibrating spatula cut along line IV illustrated in FIG. 1;

FIG. 5 is a circuit diagram illustrating an electrical configuration of a circuit board illustrated in FIG. 4; and

FIG. 6 is a view illustrating other aspects of the spatula portion illustrated in FIG. 1.

### DETAILED DESCRIPTION

Hereinafter, embodiments of the present invention will be described with reference to the drawings. Components denoted by identical reference signs in the embodiments have similar functions in the embodiments unless particularly specified otherwise, and description thereof will be omitted.

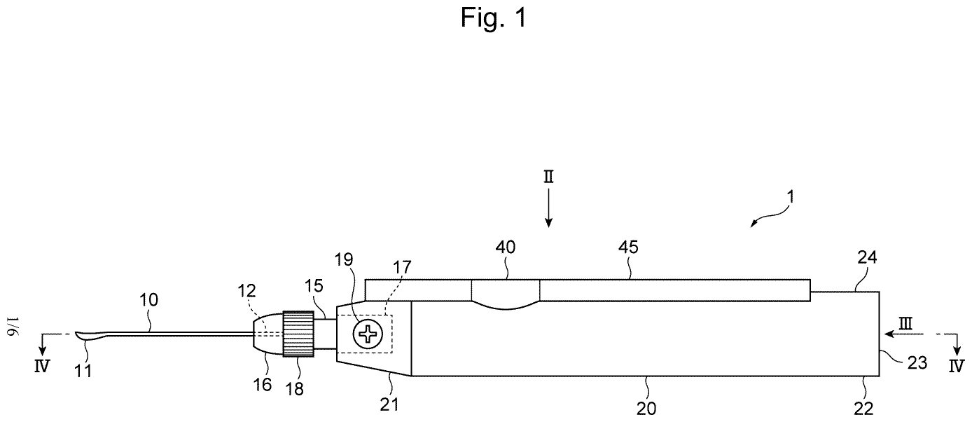

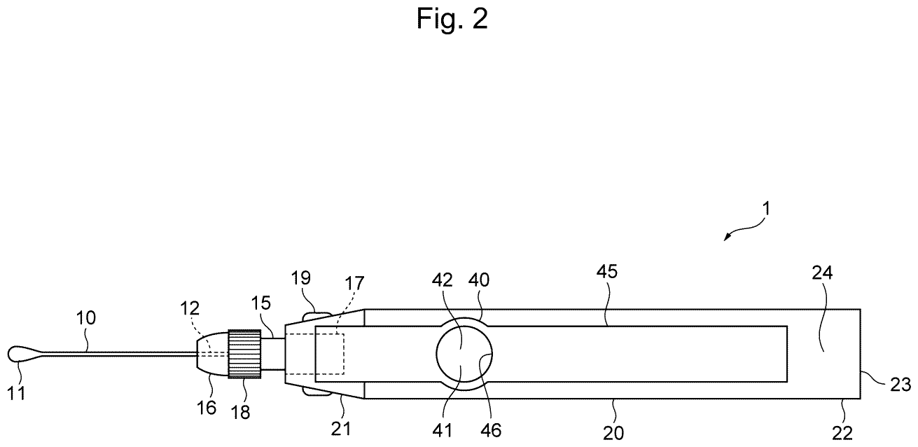

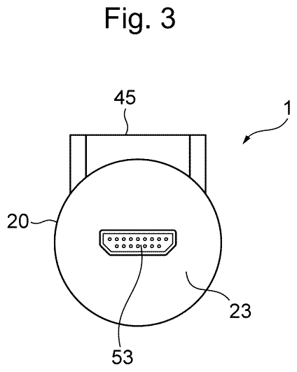

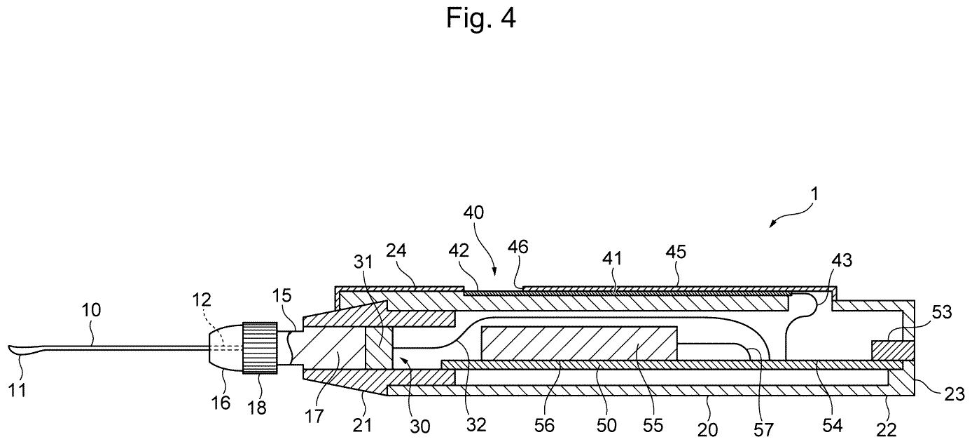

FIG. 1 is a side view of a vibrating spatula 1 according to the present embodiment. FIG. 2 is a view of the vibrating spatula 1 taken along arrow II illustrated in FIG. 1. FIG. 3 is a view of the vibrating spatula 1 taken along arrow III illustrated in FIG. 1. FIG. 4 is a cross-sectional view of a handle portion 20 of the vibrating spatula 1 cut along line IV illustrated in FIG. 1.

The vibrating spatula 1 is an electric vibrating spatula that uses electric power to vibrate a spatula portion 10. The vibrating spatula 1 is suitable as a spatula (also referred to as a “dispensing spoon”) used in the process of preparing a sample analyzed in an elemental analyzer for radiocarbon dating, when loading a sample into a container-shaped tinfoil. However, the vibrating spatula 1 may also be applicable to a spatula used when dispensing small quantities of various objects (hereinafter also referred to as “target objects”) such as a drug in granular or powder form other than the sample.

The vibrating spatula 1 includes the hollow handle portion 20 to be held by a user, and the spatula portion 10 removably attached to the distal end 21 of the handle portion 20. As illustrated in FIG. 1, the vibrating spatula 1 is rod-shaped as a whole. In each of the components of the vibrating spatula 1, an end closer to the spatula portion 10 than the handle portion 20 in the longitudinal direction is referred to as a “distal end,” whereas an end closer to the handle portion 20 than the spatula portion 10 in the longitudinal direction is referred to as a “proximal end.”

A distal end 11 of the spatula portion 10 is bowl-shaped to hold a target object. A stem portion other than the distal end 11 of the spatula portion 10 is rod-shaped. A proximal end 12 of the spatula portion 10 is removably attached to a distal end 21 of the handle portion 20 via a chuck mechanism 15. Since the spatula portion 10 is removably attachable, the vibrating spatula 1 may facilitate maintenance, including cleaning of the spatula portion 10. The spatula portion 10 vibrates in response to vibration of a vibration mechanism 30 (described later) housed inside of the handle portion 20.

The chuck mechanism 15 is tube-shaped. The proximal end 12 of the spatula portion 10 is inserted into a distal end 16 of the chuck mechanism 15. A proximal end 17 of the chuck mechanism 15 is fixed to the distal end 21 of the handle portion 20 by a screw 19 and comes into contact with the vibration mechanism 30. A sleeve 18 is provided between the distal end 16 and the proximal end 17 of the chuck mechanism 15. The sleeve 18 rotates around the axis of the chuck mechanism 15. Rotation of the sleeve 18 fastens or unfastens the proximal end 12 of the spatula portion 10 placed into the distal end 16. In this way, the distal end 16 of the chuck mechanism 15 removably fastens the spatula portion 10.

The handle portion 20 is tube-shaped. The proximal end 17 of the chuck mechanism 15 is inserted into the distal end 21 of the handle portion 20 and fixed by the screw 19. A USB port 53 is provided on an end face 23 at a proximal end 22 of the handle portion 20, as illustrated in FIG. 3. The USB port 53 is connected to a circuit board 50 (described later) housed inside of the handle portion 20.

The handle portion 20 may be made of a metal material or a resin material and is preferably made of a lightweight resin material, considering extended use. The handle portion 20 may be made with a 3D printer, for example.

A side surface 24 of the handle portion 20 is provided with a switch portion 40 to be pressed by a user holding the handle portion 20. The switch portion 40 changes a vibration state of the spatula portion 10 in accordance with the magnitude of pressing force applied by the user. Specifically, the switch portion 40 increases at least one of vibration frequency and amplitude of the spatula portion 10 as the pressing force increases. The aspect of changing the vibration state of the spatula portion 10 with respect to the magnitude of pressing force may be set appropriately.

As illustrated in FIG. 2 and FIG. 4, the switch portion 40 is configured to include a pressure sensor 41 having a pressure receiving surface 42 receiving pressing force applied by the user, and a cover 45 covering the pressure sensor 41. The pressure sensor 41 is in a film form and is provided on the side surface 24 of the handle portion 20. The pressure sensor 41 is configured with a piezoelectric element such as a piezoelectric film, for example. The pressure sensor 41 is connected to the circuit board 50 via a lead 43.

The cover 45 covers the pressure sensor 41 provided on the side surface 24 of the handle portion 20. The cover 45 has an engaging hook that is engaged with an engaging hole provided on the side surface 24. The cover 45 is removably attached to the side surface 24 by the engagement of the engaging hook with the engaging hole on the side surface 24. The cover 45 has an opening 46 that allows exposure of the pressure receiving surface 42 of the pressure sensor 41 while the pressure sensor 41 provided on the side surface 24 of the handle portion 20 is covered.

As illustrated in FIG. 4, the handle portion 20 houses therein the vibration mechanism 30 vibrating with electric power, the circuit board 50 on which a drive circuit 51 of the vibration mechanism 30 is mounted, and a storage battery 55 connected to the circuit board 50.

The vibration mechanism 30 is configured with an eccentric motor 31, for example, and is connected to the circuit board 50 via a lead 32. The vibration mechanism 30 is disposed in contact with the proximal end 17 of the chuck mechanism 15 such that the vibration is efficiently transmitted to the spatula portion 10 via the chuck mechanism 15. The vibration mechanism 30 may be configured with a piezoelectric element or an electrostriction element. However, when the vibration mechanism 30 is configured with the eccentric motor 31, the vibration mechanism 30 does not require an oscillation circuit that is necessary for the vibration mechanism 30 configured with a piezoelectric element or an electrostriction element. Thus, the vibration mechanism 30 is preferably configured with the eccentric motor 31 since this helps simplify the drive circuit 51 compared to the vibration mechanism 30 configured with a piezoelectric element or an electrostriction element.

The storage battery 55 is a power source for the vibration mechanism 30. The storage battery 55 is configured with a lithium-ion battery, for example, and is connected to the circuit board 50 via a lead 57. The storage battery 55 is charged by electric power supplied from an external power source via the USB port 53. For the vibrating spatula 1, a dry battery may be used instead of the storage battery 55. However, the storage battery 55 is preferably used since this helps make the handle portion 20 smaller and lighter as compared to the dry battery. With such a configuration, the user is less likely to experience fatigue during extended use of the vibrating spatula 1. According to the present embodiment, the vibrating spatula 1 with an excellent usability can be provided. In addition, a storage battery is preferably used since it can save the users from having to replace a battery.

The storage battery 55 is arranged between the vibration mechanism 30 and the USB port 53 in the longitudinal direction of the handle portion 20. Preferably, the storage battery 55 is arranged at the center part of the handle portion 20 in the longitudinal direction. Arranging the storage battery 55 at the center part of the handle portion 20 in the longitudinal direction may position the center of gravity of the vibrating spatula 1 near the center part of the handle portion 20 in the longitudinal direction. With such a configuration, the user is less likely to experience fatigue during extended use of the vibrating spatula 1. According to the present embodiment, the vibrating spatula 1 with an excellent usability can be provided.

The circuit board 50 is formed as an elongated plate extending in the longitudinal direction of the handle portion 20. The pressure sensor 41, the eccentric motor 31 of the vibration mechanism 30, and the storage battery 55 are connected to the circuit board 50 via the lead 43, the lead 32, and the lead 57, respectively. The drive circuit 51 of the vibration mechanism 30, a charging circuit 52 of the storage battery 55, and the USB port 53 are mounted on the circuit board 50. That is, the drive circuit 51 and the charging circuit 52 are mounted on the same circuit board 50. It is noted that a DC jack may be used instead of the USB port.

In addition, the circuit board 50 is provided with not only a mount area 54 where the drive circuit 51, the charging circuit 52, and the USB port 53 are mounted, but also an installation area 56 for the storage battery 55. The mount area 54 is provided near the proximal end 22 of the handle portion 20 in the longitudinal direction, and the installation area 56 is provided near the distal end 21 of the handle portion 20 in the longitudinal direction.

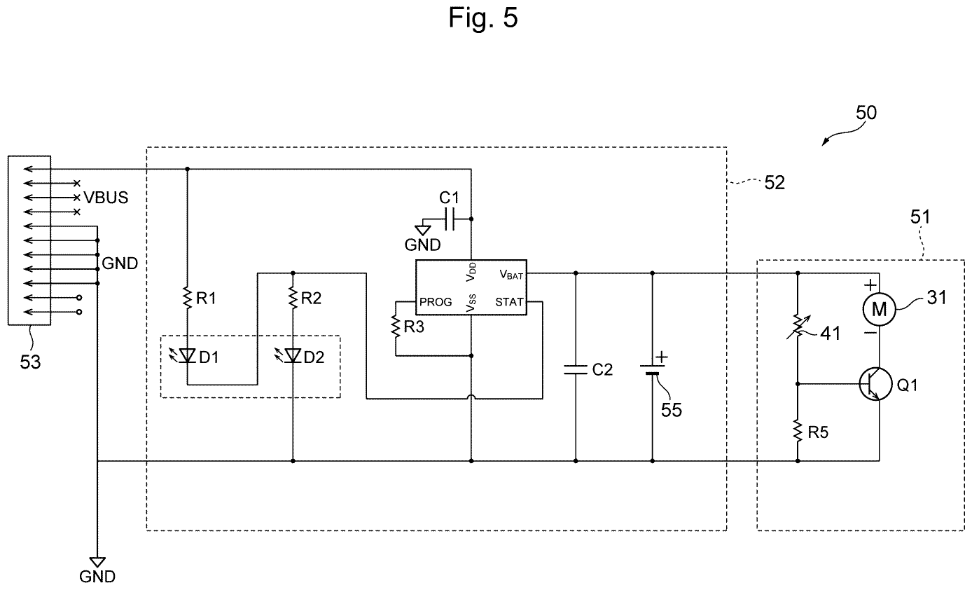

FIG. 5 is a circuit diagram illustrating an electrical configuration of the circuit board 50 illustrated in FIG. 4.

As illustrated in FIG. 5, the charging circuit 52 mounted on the circuit board 50 is connected to the USB port 53 and the storage battery 55 and charges the storage battery 55 with electric power supplied from the external power source via the USB port 53. The charging circuit 52 is a common charging circuit having a charging IC, resistors R1 to R3, and capacitors C1, C2. The charging circuit 52 may have a light-emitting diode D1 that emits light when the storage battery 55 is in a charge state, and a light-emitting diode D2 that emits light when the storage battery 55 is in a full charge state.

The drive circuit 51 mounted on the circuit board 50 is connected to the eccentric motor 31 of the vibration mechanism 30 and the storage battery 55, and drives the eccentric motor 31 with electric power supplied from the storage battery 55. The drive circuit 51 includes a transistor Q1, a resistor R5, and the pressure sensor 41 of the switch portion 40. The pressure sensor 41 changes a resistance value of the pressure sensor 41 in accordance with the magnitude of pressing force on the pressure receiving surface 42 applied by the user. The greater the pressing force on the pressure receiving surface 42, the smaller the resistance value of the pressure sensor 41. The smaller the resistance value of the pressure sensor 41, the greater the base current of the transistor Q1 and the greater the collector current of the transistor Q1. As the collector current of the transistor Q1 increases, the drive current supplied from the storage battery 55 to the eccentric motor 31 increases, and at least one of vibration frequency and amplitude of the eccentric motor 31 increases. Then, at least one of vibration frequency and amplitude of the spatula portion 10 increases.

In this manner, the drive circuit 51 changes the resistance value of the pressure sensor 41 in accordance with the magnitude of pressing force on the pressure receiving surface 42 to adjust the drive current supplied to the eccentric motor 31 in accordance with a change in the resistance value. Accordingly, the drive circuit 51 changes the vibration condition of the eccentric motor 31 and changes the vibration state of the spatula portion 10.

That is, the pressure sensor 41 functions as a variable resistor adjusting the electric power supplied to the vibration mechanism 30, and adjusts the drive power of the vibration mechanism 30 in accordance with the magnitude of pressing force on the pressure receiving surface 42. Accordingly, the pressure sensor 41 changes the vibration condition of the vibration mechanism 30 and changes the vibration state of the spatula portion 10.

It is noted that the vibrating spatula 1 may include a power cord instead of the USB port 53 and the storage battery 55. The power cord externally extends from the end face 23 at the proximal end 22 of the handle portion 20. The power cord has a power plug at one end. The other end of the power cord is connected to the circuit board 50. The drive circuit 51 drives the vibration mechanism 30 with electric power supplied from the external power source (commercial power source) via the power code. With such a configuration, the vibrating spatula 1 does not require the storage battery 55, and this helps make the handle portion 20 smaller and lighter. The user is less likely to experience fatigue during extended use of the vibrating spatula 1. According to the present embodiment, the vibrating spatula 1 with an excellent usability can be provided.

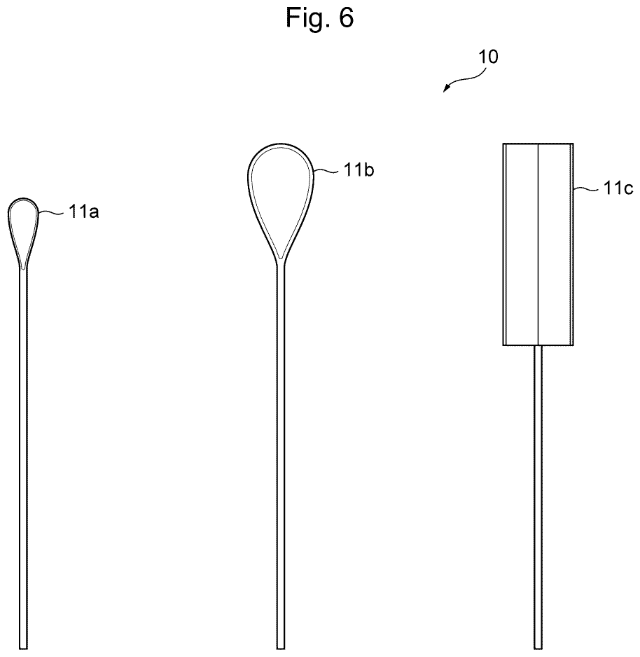

FIG. 6 is a view illustrating other aspects of the spatula portion 10 illustrated in FIG. 1.

Other aspects of the spatula portion 10 may include different shapes of the distal end 11. The left side of FIG. 6 illustrates an aspect of the spatula portion 10 having a bowl-shaped distal end 11a with a small area. The center of FIG. 6 illustrates an aspect of the spatula portion 10 having a bowl-shaped distal end 11b with a large area. The right side of FIG. 6 illustrates an aspect of the spatula portion 10 having a distal end 11c made of a pair of flat plates joined together in a V shape as viewed in a cross section. The vibrating spatula 1 may be used with the spatula portion 10 of an appropriate aspect attached thereto depending on the quantity of the target object or the size of a container to which the target object is loaded, and the like.

As described above, the vibrating spatula 1 of the present embodiment is an electric vibrating spatula, and includes the hollow handle portion 20 to be held by a user, the vibration mechanism 30 housed inside of the handle portion 20 and configured to vibrate with electric power, the spatula portion 10 removably attached to the distal end 21 of the handle portion 20 and configured to vibrate in response to vibration of the vibration mechanism 30, and the switch portion 40 provided on the handle portion 20 and configured to be pressed by the user holding the handle portion 20. The switch portion 40 changes the vibration state of the spatula portion 10 in accordance with the magnitude of pressing force applied by the user.

With such a configuration, since the spatula portion 10 is attachable to and detachable from the handle portion 20, the vibrating spatula 1 can facilitate replacement with the spatula portion 10 of an appropriate aspect depending on the quantity of the target object or the size of a container to which the target object is loaded, and the like. Additionally, the vibrating spatula 1 may facilitate maintenance, including cleaning of the spatula portion 10. Moreover, the vibrating spatula 1 can facilitate vibration of the replaced spatula portion 10 in a suitable vibration state only by changing the magnitude of pressing force applied by the user. Therefore, according to the present embodiment, it is possible to provide the electric vibrating spatula 1 capable of vibrating the spatula portion 10 of various shapes in an appropriate and intuitive manner, with excellent usability.

Furthermore, in the vibrating spatula 1 of the present embodiment, the switch portion 40 increases at least one of vibration frequency and amplitude of the spatula portion 10 as the pressing force applied by a user increases.

With such a configuration, the user only needs to increase the pressing force when stronger vibration of the spatula portion 10 is needed and thus the vibrating spatula 1 can change the vibration state of the spatula portion 10 in a manner that matches user intuition. Therefore, according to the present embodiment, it is possible to provide the electric vibrating spatula 1 capable of vibrating the spatula portion 10 of various shapes in an appropriate and intuitive manner, with more excellent usability.

Furthermore, in the vibrating spatula 1 of the present embodiment, the switch portion 40 is configured to include the pressure sensor 41 having the pressure receiving surface 42 receiving pressing force applied by the user. The pressure sensor 41 changes the vibration state of the spatula portion 10 by adjusting the drive power of the vibration mechanism 30 in accordance with the magnitude of pressing force on the pressure receiving surface 42.

With such a configuration, the vibrating spatula 1 can change the vibration state of the spatula portion 10 in accordance with the magnitude of pressing force applied by the user, without requiring a complicated configuration. Therefore, according to the present embodiment, it is possible to easily provide the electric vibrating spatula 1 capable of vibrating the spatula portion 10 of various shapes in an appropriate and intuitive manner, with excellent usability.

Furthermore, the vibrating spatula 1 of the present embodiment includes the circuit board 50 housed inside of the handle portion 20 and on which the drive circuit 51 of the vibration mechanism 30 is mounted. The vibration mechanism 30 is configured with the eccentric motor 31. The drive circuit 51 changes the vibration state of the spatula portion 10 by changing a resistance value of the pressure sensor 41 in accordance with the magnitude of pressing force on the pressure receiving surface 42 to adjust the drive current supplied to the eccentric motor 31 in accordance with a change in the resistance value.

With such a configuration, the vibrating spatula 1 does not require an oscillation circuit that is necessary for the vibration mechanism 30 configured with a piezoelectric element or an electrostriction element, and thus can simplify the drive circuit 51. Thus, the vibrating spatula 1 can have mounted thereon the drive circuit 51, which is inexpensive and rugged. Therefore, according to the present embodiment, it is possible to provide the electric vibrating spatula 1 capable of vibrating the spatula portion 10 of various shapes in an appropriate and intuitive manner, with more excellent usability.

Furthermore, in the vibrating spatula 1 of the present embodiment, the switch portion 40 is configured to include the pressure sensor 41 having the pressure receiving surface 42 receiving pressing force and the cover 45 covering the pressure sensor 41. The handle portion 20 is tube-shaped. The pressure sensor 41 is in a film form and is provided on the side surface 24 of the handle portion 20. The cover 45 covers the pressure sensor 41 provided on the side surface 24 of the handle portion 20.

With such a configuration, the vibrating spatula 1 can easily achieve the switch portion 40 without requiring a complicated configuration. Therefore, according to the present embodiment, it is possible to more easily provide the electric vibrating spatula 1 capable of vibrating the spatula portion 10 of various shapes in an appropriate and intuitive manner, with excellent usability.

Furthermore, in the vibrating spatula 1 of the present embodiment, the cover 45 has the opening 46 that allows exposure of the pressure receiving surface 42 while the pressure sensor 41 provided on the side surface 24 of the handle portion 20 is covered.

With such a configuration, the vibrating spatula 1 can increase responsiveness of the pressure sensor 41 with respect to pressing force without requiring a complicated configuration. Thus, the vibrating spatula 1 can further change the vibration state of the spatula portion 10 in manner that matches user intuition. Therefore, according to the present embodiment, it is possible to provide the electric vibrating spatula 1 capable of vibrating the spatula portion 10 of various shapes in an appropriate and further intuitive manner, with more excellent usability.

Furthermore, the vibrating spatula 1 of the present embodiment includes the chuck mechanism 15 fixed to the distal end 21 of the handle portion 20. The distal end 16 of the chuck mechanism 15 removably fastens the spatula portion 10, and the proximal end 17 of the chuck mechanism 15 comes in contact with the vibration mechanism 30.

With such a configuration, the vibrating spatula 1 can facilitate replacement of the spatula portion 10 and can efficiently transmit the vibration of the vibration mechanism 30 to the spatula portion 10. Therefore, according to the present embodiment, it is possible to provide the electric vibrating spatula 1 capable of vibrating the spatula portion 10 of various shapes in a further appropriate and further intuitive manner, with more excellent usability.

Furthermore, the vibrating spatula 1 of the present embodiment includes the circuit board 50 housed inside of the handle portion 20 and on which the drive circuit 51 of the vibration mechanism 30 is mounted, and the storage battery 55 housed inside of the handle portion 20 and connected to the circuit board 50. The drive circuit 51 drives the vibration mechanism 30 with electric power supplied from the storage battery 55.

With such a configuration, it is possible to realize the vibrating spatula 1 that is electrically operated and has a cordless structure without a power cord. Furthermore, this vibrating spatula 1 helps make the handle portion 20 smaller and lighter as compared to the vibrating spatula 1 using a dry battery, and thus the user is less likely to experience fatigue during extended use of the vibrating spatula 1. Accordingly, the vibrating spatula 1 can have an improved operability as compared to the vibrating spatula 1 using the dry battery. Therefore, according to the present embodiment, it is possible to provide the electric vibrating spatula 1 capable of vibrating the spatula portion 10 of various shapes in an appropriate and intuitive manner, with more excellent usability.

Furthermore, the vibrating spatula 1 of the present embodiment includes the USB port 53 provided on the proximal end 22 of the handle portion 20 and connected to the circuit board 50. The storage battery 55 is charged by electric power supplied from an external power source via the USB port 53.

With such a configuration, even when the vibrating spatula 1 is used with a cable inserted into the USB port 53 to charge the storage battery 55, the cable will not be a bother when using the vibrating spatula 1, and thus the vibrating spatula 1 can have an improved operability. Therefore, according to the present embodiment, it is possible to provide the electric vibrating spatula 1 capable of vibrating the spatula portion 10 of various shapes in an appropriate and intuitive manner, with more excellent usability.

Furthermore, the vibrating spatula 1 of the present embodiment includes the circuit board 50 housed inside of the handle portion 20 and on which the drive circuit 51 of the vibration mechanism 30 is mounted, and the power cord extending from the proximal end 22 of the handle portion 20 and having a power plug. The drive circuit 51 drives the vibration mechanism 30 with electric power supplied from the external power source via the power code.

With such a configuration, this vibrating spatula 1 helps make the handle portion 20 smaller and lighter as compared to the vibrating spatula 1 using the storage battery 55 or a dry cell as a power source for the vibration mechanism 30, and thus the user is less likely to experience fatigue during extended use of the vibrating spatula 1. Therefore, according to the present embodiment, it is possible to provide the electric vibrating spatula 1 capable of vibrating the spatula portion 10 of various shapes in an appropriate and intuitive manner, with more excellent usability.

Although the embodiments of the present invention have been described in detail above, the present invention is not limited to the above embodiments, and various changes are possible as far as they are within the spirit of the present invention. In the present invention, it is possible to add, to a component of an embodiment, a component of another embodiment, to replace a component of an embodiment with a component of another embodiment, or to delete a part of a component of an embodiment.

### DESCRIPTION OF SYMBOLS

1 Vibrating spatula
10 Spatula portion
11, 11a to 11cDistal end
12 Proximal end
15 Chuck mechanism
16 Distal end
17 Proximal end
18 Sleeve
19 Screw
20 Handle portion
21 Distal end
22 Proximal end
23 End face
24 Side surface
30 Vibration mechanism
31 Eccentric motor
32 Lead
40 Switch portion
41 Pressure sensor
42 Pressure receiving surface
43 Lead
45 Cover
46 Opening
50 Circuit board
51 Drive circuit
52 Charging circuit
53 USB port
54 Mount area
55 Storage battery
56 Installation area
57 Lead

What is claimed is:

1. A vibrating spatula of an electric type comprising:
a handle portion to be held by a user, the handle portion being hollow;
a vibration mechanism housed inside of the handle portion and configured to vibrate with electric power;
a spatula portion removably attached to a distal end of the handle portion and configured to vibrate in response to vibration of the vibration mechanism; and
a switch portion provided on the handle portion and configured to be pressed by the user holding the handle portion,
wherein the switch portion changes a vibration state of the spatula portion in accordance with a magnitude of pressing force applied by the user.

2. The vibrating spatula according to claim 1, wherein the switch portion increases at least one of vibration frequency and amplitude of the spatula portion as the pressing force increases.

3. The vibrating spatula according to claim 2,
wherein the switch portion is configured to include a pressure sensor having a pressure receiving surface receiving the pressing force, and
wherein the pressure sensor changes the vibration state of the spatula portion by adjusting a drive power of the vibration mechanism in accordance with the magnitude of the pressing force on the pressure receiving surface.

4. The vibrating spatula according to claim 3, further comprising a circuit board housed inside of the handle portion and on which a drive circuit of the vibration mechanism is mounted,
wherein the vibration mechanism is configured with an eccentric motor, and
wherein the drive circuit changes the vibration state of the spatula portion by changing a resistance value of the pressure sensor in accordance with the magnitude of the pressing force on the pressure receiving surface to adjust a drive current supplied to the eccentric motor in accordance with a change in the resistance value.

5. The vibrating spatula according to claim 2,
wherein the switch portion is configured to include a pressure sensor having a pressure receiving surface receiving the pressing force and a cover covering the pressure sensor,
wherein the handle portion is tube-shaped,
wherein the pressure sensor is in a film form and is provided on a side surface of the handle portion, and
wherein the cover covers the pressure sensor provided on the side surface of the handle portion.

6. The vibrating spatula according to claim 5, wherein the cover has an opening that allows exposure of the pressure receiving surface while the pressure sensor provided on the side surface of the handle portion is covered.

7. The vibrating spatula according to claim 2, further comprising a chuck mechanism fixed to the distal end of the handle portion,
wherein a distal end of the chuck mechanism removably fastens the spatula portion, and
wherein a proximal end of the chuck mechanism comes in contact with the vibration mechanism.

8. The vibrating spatula according to claim 2, further comprising: a circuit board housed inside of the handle portion and on which a drive circuit of the vibration mechanism is mounted; and a storage battery housed inside of the handle portion and connected to the circuit board,
wherein the drive circuit drives the vibration mechanism with electric power supplied from the storage battery.

9. The vibrating spatula according to claim 8, further comprising a USB port provided on a proximal end of the handle portion and connected to the circuit board,
wherein the storage battery is charged by electric power supplied from an external power source via the USB port.

10. The vibrating spatula according to claim 2, further comprising: a circuit board housed inside of the handle portion and on which a drive circuit of the vibration mechanism is mounted; and a power cord extending from a proximal end of the handle portion and having a power plug,
wherein the drive circuit drives the vibration mechanism with electric power supplied from an external power source via the power cord.
